(19) United States
(12) Patent Application Publication
(10) Pub. No.: US 2015/0133358 A1
(43) Pub. Date: May 14, 2015

(54) BLEACH-FREE LAUNDRY POWDER DETERGENT WITH NANOPARTICLES

(71) Applicant: Tolypers Company, Qazvin (IR)

(72) Inventors: Mohammadreza Khanmohammadi Khorrami, Qazvin (IR); Masumeh Rostami arbastan, Qazvin (IR); Fatemeh Abdi, Tehran (IR)

(73) Assignee: Tolypers Company, Qazvin (IR)

(21) Appl. No.: 14/536,619

(22) Filed: Nov. 8, 2014

Related U.S. Application Data
(60) Provisional application No. 61/902,158, filed on Nov. 9, 2013.

(51) Int. Cl. C11D 11/00; C11D 3/12; C11D 1/831

(52) U.S. Cl. CPC C11D 11/0017; C11D 1/831; C11D 3/1206
USPC 510/357; 510/276; 510/360

(57) ABSTRACT

A bleach-free laundry detergent composition containing zero-valent iron nanoparticles. A small amount of nanoparticles with a size range of about 100 nm to about 500 nm replace the bleach and consequently the bleach activator in the laundry detergent composition. These nanoparticles are capable of oxidization which makes them an appropriate alternative for the bleach in a laundry detergent.

### CROSS REFERENCE TO RELATED APPLICATION

The present invention claims priority from pending U.S. Provisional Patent Application Ser. No. 61/902,158, filed Nov. 9, 2013, entitled “Bleach-free laundry powder detergent with nanoparticles,” the subject matter of which is incorporated by reference herein in its entirety.

### SPONSORSHIP STATEMENT

This application has been sponsored by the Iranian Nanotechnology Initiative Council, which does not have any rights in this application.

### TECHNICAL FIELD

This application generally relates to a laundry detergent composition, and more particularly relates to a bleach-free laundry detergent composition containing nanoparticles.

### BACKGROUND OF THE INVENTION

The word “detergent” generally refers to any powder or liquid used for washing and removing stains from clothes. A machine powder detergent generally includes anionic and cationic surfactants, builders, fillers, bleaches, activators, soaps, essence, and performance enhancing substances, such as optical brighteners, enzymes, and other components.

Bleaches are well-known compositions commonly found in formulations associated with washing machine powders, dishwasher powders, and hard surface cleaners. They remove chromophores through an oxidization mechanism. Bleaches are commonly either chlorine-based or peroxide-based.

For example, trichloroisocyanuric acid, having the formula C₃Cl₃N₃O₃, is a chlorinated bleach agent used both as a whitener and a disinfectant. It is more stable than sodium hypochlorite solution. Since it is highly oxidant, special attention must be paid to safety guidelines when using it. Trichloroisocyanuric acid and its sodium salt, sodium dichloroisocyanurate, are used as chlorination agents, disinfectants, and industrial antiseptics and antifungals.

Peroxide-based bleaches, also called active oxygen bleaches, include sodium perborate, sodium percarbonate, and urea peroxide. Sodium perborate acts as a source of active oxygen in many detergents and cleaning products, and releases active oxygen at high temperatures, but it also amplifies the growth of aquatic plants when released in the environment. This reduces oxygen in the water and results in the death of aquatic organisms. Sodium percarbonate, an adduct of sodium carbonate and hydrogen peroxide, releases H₂O₂ and sodium carbonate when dissolved in water. The resulting solution has an alkaline pH, which activates the H₂O₂ for bleaching. Sodium percarbonate can also be used in household detergents, disinfectants, and food bleaching materials.

Peroxide-based bleaches are activated only at high temperatures or in the presence of activators. These activators, also known as bleach precursors, often come in the form of esters or carboxylic acid amides. In washing liquids, hydrogen peroxide anions react with the ester or amide and produce peroxy of the acid, which then oxidizes the stained substrate. Detergent industries primarily use Tetra Acetyl Ethylene Diamine (TAED) as the bleach activator. In alkaline water and in the presence of perborate or percarbonate, as a hydrogen peroxide source, TAED undergoes rapid perhydrolysis, producing peracetate and Diacetyl Ethylene Diamine (DAED). However, DAED is not easily hydrolyzed, and is prone to biological decomposition. The produced peracetate oxidizes the stains and is converted to acetate. An assessment of the underlying kinetics of the bleaching process reveals that the reaction depends on pH and to some extent on temperature.

Today, peroxide bleaches are generally used in detergent industries. This type of bleach, as mentioned above, is activated only at high temperatures. High temperatures, however, increase the inherent energy consumption and also damage the textiles being washed. In order to be able to use these caustic bleaches at lower temperatures, expensive activators, such as the aforesaid TAED, must be used.

There is, accordingly, a present need to provide improved compositions for use in washing machine powders, dishwasher powders, and hard surface cleaners.

It is, therefore, an object of the present invention to provide improved compositions that ameliorate or eliminate the destructive properties inherent in commercial and consumer bleaches, particularly those employing peroxides at high temperatures.

It is also an object of the present invention to completely remove bleaches from detergents and like products, offering bleach-free cleaning compositions.

These objects are met in various embodiments of the present invention where there is a significant reduction in damage to textiles and other materials when cleaned in the cleaning compositions of the present invention. As a result of this advancement in the technology, clothes and other materials can be cleaned without fear of damage to the clothes caused by the cleaning process itself, which is a constant worry of countless millions of consumers employing bleach-based products. Accordingly, the improved, bleach-free compositions of the present invention offer significant advantages over the known prior art.

### SUMMARY OF THE INVENTION

A bleach-free laundry detergent composition containing zero-valent iron nanoparticles is disclosed. A small amount of nanoparticles, with a size range of about 100 nm to about 500 nm, replace the bleach, and, consequently, the bleach activator in laundry detergent compositions. These nanoparticles are capable of oxidization, which makes them an appropriate alternative for the corrosive bleach in a laundry detergent.

In a preferred embodiment, the laundry detergent composition of the present invention includes a detergent surfactant, such as anionic surfactants, nonionic surfactants, and mixtures thereof; a builder, such as sodium tripolyphosphate, sodium carbonate, a zeolite, trisodium maleate/acrylate copolymer, and mixtures thereof; an effective amount of zero-valent iron nanoparticles with a size range of about 100 nm to about 500 nm, with the composition being free of bleach compounds.

In further preferred embodiments the compositions of the present invention include about 4 wt % to about 20 wt % of alkylbenzene sulfonate, as the anionic surfactant, and about 3 wt % to 10 wt % of poly oxy ethylene (9) nonyl phenol ether, as the nonionic surfactant, and about 5 wt % to about 30 wt % of sodium tripoly phosphate; about 5 wt % to about 25 wt % of sodium carbonate; about 4 wt % to about 20 wt % of a zeolite; and about 2 wt % to about 8 wt % of trisodium maleate/acrylate copolymer, as the detergency builder.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying DRAWINGS, where like reference numerals designate like structural and other elements, in which:

FIG. 1 is a scanning electron microscope image of exemplary nano zero-valent iron (nZVI) particles, such as are employed in practicing the principles of the present invention in cleaning compositions; and

FIG. 2 is a scanning electron microscope image of an exemplary powder sample stored for 6 months, indicating the existence of remaining nanoparticles therein.

### DETAILED DESCRIPTION OF THE INVENTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

As discussed hereinabove, the present invention addresses the serious and long-time problems associated with employing bleach agents, such as used in laundry detergent compositions, especially peroxide-based bleaching materials. Applicant has found that a small amount of nanoparticles, with a size range of about 100 nm to about 500 nm, can entirely replace bleaches and bleach agents in laundry detergent compositions. The bleach-free compositions of the instant invention thus enable the use of laundry detergent powders at normal temperatures, not elevated temperatures, which reduces the energy consumption. Also, elimination of high temperatures results in less damage to the textiles and other materials being cleaned or washed.

Regarding the efficacy of the improved compositions set forth herein, the most immediate outcome of downscaling particles to nanoscale is the large increase of overall contact area. When the surface-to-volume ratio of the particles increases, atoms located at the surface have greater impact on the physical properties of the particles compared to those residing inside the volume of the particles, which are covered. This greatly improves the reactivity of the nanoparticles.

Furthermore, nanoscaling a particle changes its ionization potential. Studies reveal that smaller particles have higher ionization potentials. In other words, the bigger the particles become, the smaller their ionization potential. Increased surface-to-volume ratios and changes in the geometry and electronical structure heavily influence the chemical reactions of the material. At nano scale, quantities such as surface-to-volume ratio and potential energy rise considerably. These changes have a great impact on the capabilities of the product.

### Zero-Valent Iron Nanoparticles

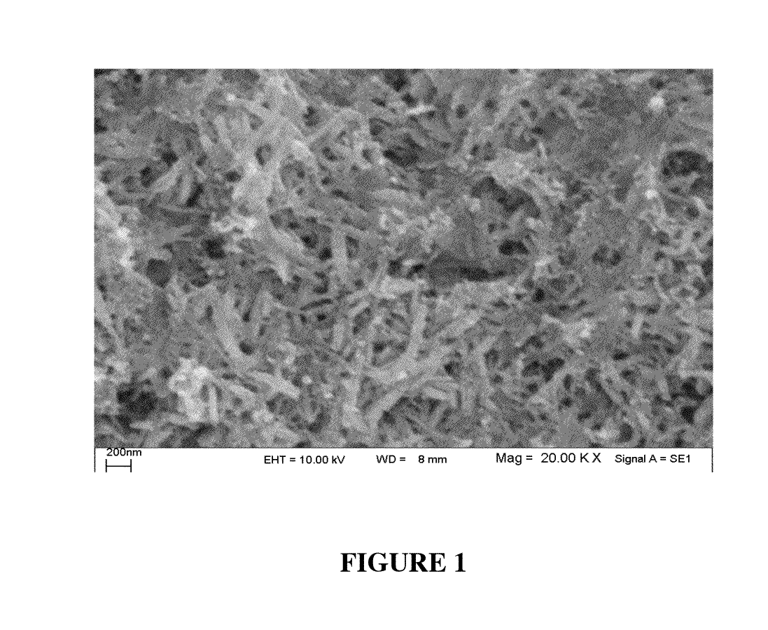

In a preferred embodiment, zero-valent iron nanoparticles (nZVI) with an average size of 100 nm to 500 nm, such as illustrated in FIG. 1 of the DRAWINGS, are used in this invention. It should be understood that nZVI particles have high surface activity, due to their specific area, and thus they are unique catalysts. Furthermore, nZVI is Redox active and produces active oxygen with high reactivity. This is exactly what is expected from a bleach in machine powder formulations, and the reason they are so employed.

Among its other properties, Applicant has found that nZVI absorbs organic dyes, which amplifies the bleaching effect. Accordingly, nZVI is used as a reducing agent and as a catalyst for detoxification of various pollutants, such as solvents, chlorinated organic pesticides, polychloride biphenyls, nitrates and heavy metals.

Exemplary nZVI reactions include:

2Fe0+4H++O2→2Fe2++2H2O

Fe0+2H2O→Fe2++H2+2OH−

Fe0+2H2O→Fe2++H2+2OH−

It should be understood that nZVI must be kept from contact with oxidants, acids, halogens, water and moisture. Furthermore, products employing nZVI must be stored in cool and dry places.

It should further be understood that nZVI particles can also act as an optical brightener in a laundry powder, e.g., by forming a thin film of nanoparticles in the environment, which absorbs 1.03-1.15 μm wavelengths. An energy jump occurs and other wavelengths are dispersed. This gives the product the capability of also acting as an optical brightener.

The present invention has an additional advantage of being environmentally friendly. Whereas sodium perborate, a routinely-used bleach in the industry that deleteriously amplifies the growth of aquatic plants, reduces oxygen in the water, and results in the death of aquatic organisms, the present invention can avoid all of these downsides simply by replacing sodium perborate with a small amount of nZVI.

In a preferred embodiment of the present invention, the level of zero-valent iron nanoparticles present in detergent compositions of the present invention is preferably from about 0.2 wt % to about 0.6 wt %.

Further, the detergent compositions of the present invention preferably contain at least one detergent surfactant, will generally contain at least one detergency builder, and may optionally contain other active ingredients to enhance performance and properties, as is understood in the art.

### Surfactants

Surfactants that may be employed with the present invention include anionic surfactants, nonionic surfactants, and mixtures thereof.

Suitable anionic surfactants useful herein include any of the conventional anionic surfactant types. In a more specific embodiment, linear alkyl benzene sulfonate is used as an anionic surfactant. The preferred level of anionic surfactant, when employed in the present invention, is from about 4 wt % to about 20 wt %. Other anionic surfactants suitable for use with the invention are well-known to those skilled in the art.

Suitable nonionic surfactants useful herein include any of the conventional nonionic surfactant types. In a more specific embodiment poly oxy ethylene (9) nonyl phenol ether is used as a nonionic surfactant. The preferred level of nonionic surfactant is from about 3 wt % to about 10 wt %.

### Detergency Builders

The detergent compositions of the instant invention will generally also contain one or more detergency builders. In a more specific embodiment, sodium carbonate with a preferred level of about 5 wt % to about 25 wt %, and a zeolite with a preferred level of about 4 wt % to 20 wt % are used as detergency builders. The zeolite may be commercially-available zeolite 4A, as now widely-used in laundry detergent powders. It should, of course, be understood that alternative builders and zeolites may be employed in practicing the principles of the present invention.

### Other Materials

It should also be understood that other materials that may be present in detergent compositions of the invention, which include sodium silicate, with a preferred level of about 4 wt % to about 15 wt %; antiredeposition agents, such as cellulosic polymers, with a preferred level of about 1 wt % to about 3 wt %; optical brighteners, with a preferred level of 0.5 wt % to 1 wt %; and perfumes, with a preferred level of 0.1 wt % to 0.4 wt %. It should further be understood that the aforesaid list of materials set forth hereinabove is not meant to be exhaustive.

### Example

### Performance Test

To produce machine detergent powders in a first illustrative embodiment of the present invention, the first step is to add the active component (Linear Alkyl Benzene or LABSNa) to stearic acid. This results in a smooth paste. Then the paste is mixed with sodium sulfate, sodium silicate and sodium tripolyphosphate. Sufficient time is given to the sodium tripolyphosphate for hydration, as is understood in the art. The resulting uniform paste is referred to as a “slurry.” Next, the slurry is mixed with other materials, such as sodium carbonate, optical brighteners and carboxy methyl cellulose. The mixture is then homogenized and sprayed through 20 or so nozzles of a spray drying tower, which is about 40 m high and at a temperature of about 300-400° C. Being exposed to the hot air rising through the tower, the paste dries by the time it reaches the bottom and turns into a white powder.

Then, the powder is sieved to leave out any possible trash or impuirities. Then, to complete the formulation, sodium perborate or Sodium percarbonate (as the bleach), TAED as the activator, essence and other optional materials are added. The powder is ready for packaging.

In the present invention, however, nanoparticles are added to the powder exactly at the same time when the bleach and bleach activator are supposed to be added. Therefore, the conventional process of production remains unchanged.

To compare the new product with the control powder, performance tests have been run. First, two series of Swiss-standard spots called EMPA with codes 104, 106, 119, 111, 112, 116, 211 and 213, corresponding to soiling, carbon black, sebum, blood, cocoa, blood-milk-carbon black, and spots of two different substances without optical brightener, respectively, were cut in 6 by 6 cm pieces. Then 4 g of the blank powder and 4 g of the new powder are weighed separately using a scale to an accuracy of 4 decimal places. Now, each of the two cylindrical containers of the Tergotometer is filled with 1 L of 300 ppm hard water. Then, powders are added. After the device is operated for a minute, each series of the textiles are put in one container. Washing continues for 15 minutes. Finally, the textiles are rinsed using 300 ppm hard water and then placed between blotting papers to dry. Now, the amount of light passing through each spot in a wavelength of 460 nm is measured. A similar measurement is done on the unwashed series. Stain removal is calculated using the difference between the amount of light passing through the unwashed samples and the amount of light passing through the washed samples, and it is reported as a percentage relative to the blank powder stain removal performance in the table below.

TABLE 1

| Standard | Wash | Wash | Wash |
|---|---|---|---|
| Stain | Cycle 1 | Cycle 2 | Cycle 3 |
| Soiling | 105.882 | 104 | 107.143 |
| Carbon | 109.375 | 108.571 | 124.138 |
| black | | | |
| Sebum | 96 | 97.436 | 81.08 |
| Blood | 97.959 | 96 | 97.92 |
| Cocoa | 172.41 | 168 | 168.75 |
| Blood- | 500 | 550 | 700 |
| milk- | | | |
| cocoa | | | |
| 211 | 101.481 | 101.449 | 103.225 |
| 213 | 101.754 | 101.639 | 108.654 |

The overall composition of the powder used in these measurements, pursuant to a preferred embodiment of the present invention, is given in the table below.

TABLE 2
Component % by weight

| | |
|---|---|
| Sodium Sulfate | 40.05 |
| Sodium tripolyphosphate | 12 |
| Alkylbenzene sulfonic acid | 8.3 |
| Sodium carbonate | 8 |
| Zeolite 4A | 6 |
| Sodium silicate | 5.6 |
| Poly oxy ethylene (9) nonyphenol ether | 3.5 |
| Stearic acid | 4 |
| Trisodium maleate/acrylate copolymer | 2 |
| Sodium hydroxide | 1.58 |
| Sodium Carboxymethylcellulose | 1.5 |
| Sodium toluenesulfonate | 1 |
| Optical brightener stilbene base | 1 |
| Zero-valent iron nanoparticles | 0.3 |
| Fragrance | 0.1 |
| Dionized Water | 5.07 |
| Total: | 100 |

As is perceived from the performance chart, the powder containing NZVI exhibits the same stain removing capability as the blank powder and it even exhibits better performance on the removal of Blood-Milk-Cocoa and cocoa standard stains. The accuracy and repeatability of the tests is confirmed through repeated runs of the tests.

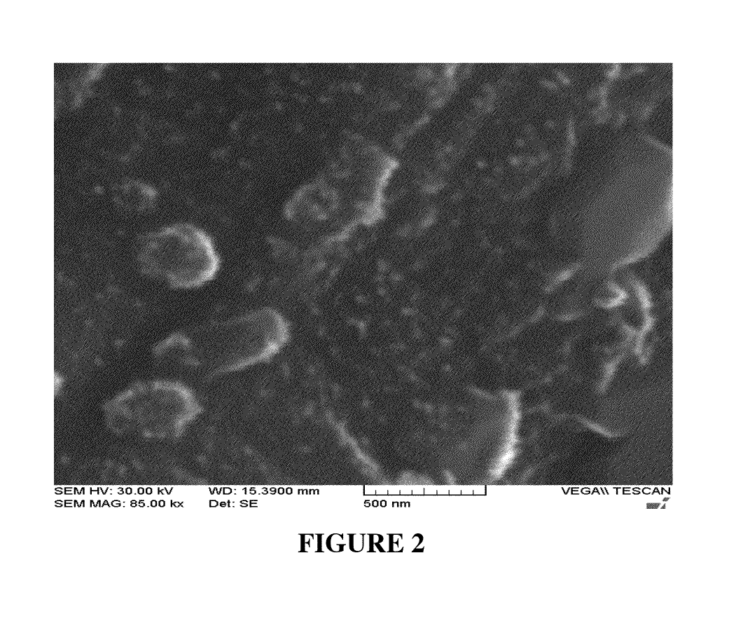

A similar performance test was run six months after the aforesaid prototyping. The results indicate that the stability of the nanoparticles in the product and the SEM range of the powder sample indicates the existence of the nanoparticles in the product, such as illustrated in FIG. 2 of the DRAWINGS.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the breadth or scope of the applicant's concept. Furthermore, although the present invention has been described in connection with a number of exemplary embodiments and implementations, the present invention is not so limited but rather covers various modifications and equivalent arrangements, which fall within the purview of the appended claims.

What is claimed is:

1. A bleach-free laundry detergent composition comprising:
a detergent surfactant;
a builder; and
an amount of zero-valent iron nanoparticles about 0.2% to about 0.6% by weight,
wherein the detergent composition is free of bleach compounds.

2. The bleach-free laundry detergent according to claim 1, wherein said detergent surfactant is selected from the group consisting of anionic surfactants, nonionic surfactants, and mixtures thereof.

3. The bleach-free laundry detergent according to claim 2, wherein said anionic surfactants comprise about 4 wt % to about 20 wt % of said detergent.

4. The bleach-free laundry detergent according to claim 2, wherein said anionic surfactants comprise alkylbenzene sulfonate.

5. The bleach-free laundry detergent according to claim 2, wherein said nonionic surfactants comprise about 3 wt % to 10 wt % of said detergent.

6. The bleach-free laundry detergent according to claim 2, wherein said nonionic surfactants comprise poly oxy ethylene (9) nonyl phenol ether.

7. The bleach-free laundry detergent according to claim 1, wherein said builder is selected from the group consisting of sodium tripolyphosphate, sodium carbonate, a zeolite, a copolymer, and mixtures thereof.

8. The bleach-free laundry detergent according to claim 7, wherein said sodium tripolyphosphate is about 5 wt % to about 30 wt %.

9. The bleach-free laundry detergent according to claim 7, wherein said sodium carbonate is about 5 wt % to about 25 wt %.

10. The bleach-free laundry detergent according to claim 7, wherein said zeolite is about 4 wt % to about 20 wt %.

11. The bleach-free laundry detergent according to claim 7, wherein said copolymer comprises a trisodium maleate/acrylate copolymer.

12. The bleach-free laundry detergent according to claim 7, wherein said copolymer comprises about 2 wt % to about 8 wt %.

13. The bleach-free laundry detergent according to claim 1, wherein said zero-valent iron nanoparticles are about 0.3% by weight.

14. The bleach-free laundry detergent according to claim 1, wherein said zero-valent iron nanoparticles have an average size of about 100 nm to about 500 nm.

15. The bleach-free laundry detergent according to claim 1, wherein said composition is shelf stable for at least 6 months.

16. The bleach-free laundry detergent according to claim 1, wherein said composition is shelf stable for at least one year.

17. The bleach-free laundry detergent according to claim 1, further comprising sodium silicate about 4 wt % to about 15 wt %.

18. The bleach-free laundry detergent according to claim 1, further comprising cellulosic polymers about 1 wt % to about 3 wt %.

19. The bleach-free laundry detergent according to claim 1, further comprising optical brighteners about 0.5 wt % to about 1 wt %.

20. The bleach-free laundry detergent according to claim 1, further comprising perfumes about 0.1 wt % to about 0.4 wt %.

21. A bleach-free laundry detergent composition comprising:
a detergent surfactant containing anionic and nonionic surfactants;
a builder; and
an amount of zero-valent iron nanoparticles about 0.2% to about 0.6% by weight,
wherein the detergent composition is free of bleach compounds.
